(19) United States
(12) Patent Application Publication
(10) Pub. No.: US 2015/0217244 A1
(43) Pub. Date: Aug. 6, 2015

(54) SYSTEM AND METHOD FOR PROCESSING DISPERSED SYSTEMS

(71) Applicant: Lev Amusin, Laguna Niguel, CA (US)

(72) Inventor: Lev Amusin, Laguna Niguel, CA (US)

(21) Appl. No.: 14/492,149

(22) Filed: Sep. 22, 2014

Related U.S. Application Data
(62) Division of application No. 14/260,846, filed on Apr. 24, 2014.
(60) Provisional application No. 61/965,711, filed on Feb. 6, 2014.

(51) Int. Cl. B01F 11/02; B01F 3/04

(52) U.S. Cl. CPC B01F 11/0291; B01F 11/0266; B01F 3/04

(57) ABSTRACT

A system and method for processing dispersed systems. A dispersed system may be processed in a reactor, attached to which there may be a vibration unit, and one or more supply lines for gases and liquids. The dispersed system may be subjected to vibroturbulization as a way to mix and process the system. Various combinations of materials may be used in such an application, and both static and dynamic processing systems are possible.

### CROSS-REFERENCE TO RELATED APPLICATIONS

This application claims priority to U.S. Provisional Patent Application No. 61/965,711 filed Feb. 6, 2014 and entitled VIBROTURBULIZATION, the entire contents of which are hereby incorporated by reference.

### BACKGROUND

Among the advanced processes of modern chemical technology, cavitation is used as a means to increase the interface between adjacent physical phases. The process of cavitation is the formation of small bubbles caused by forces of a mechanical, physicomechanical, and physical nature acting on the liquid. The formation of small bubbles usually occurs when liquid is pumped through orifices in chemical reactors. The fast promotion of the liquid causes the development of bubbles inside the liquid in zones where the pressure is relatively low.

Cavitation is usually divided into two classes of behavior: inertial (or transient) cavitation and non-inertial cavitation. Inertial cavitation is the process in which bubbles in a liquid rapidly collapse, producing a shock wave. It is a significant cause of wear in engineering equipment, such as apparatuses, reactors, pipes, pump impellers, and other parts. It can also occur in the presence of an acoustic field. Microscopic gas bubbles that are generally present in a liquid are forced to oscillate because of applied acoustic energy. If the acoustic intensity is sufficiently high, bubbles will first grow in size and then rapidly collapse. Non-inertial cavitation is the process in which bubbles in a fluid are forced to oscillate in size or shape because of some form of energy input. Such cavitation is used for ultrasonic cleaning and can also be observed in pumps, propellers, impellers, etc. Non-inertial cavitation is the process in which small bubbles in a fluid are forced to oscillate in the presence of an acoustic field, when the intensity of the acoustic field is insufficient to cause total bubble collapse. This form of cavitation causes significantly less erosion than inertial cavitation, and is often used for the cleaning of delicate mechanical parts, such as silicon wafers.

In chemical engineering, cavitation is often used to homogenize or mix and break down, dispersed phase (particles) in a colloidal liquid compound. Many industrial mixing machines are based on this design principle. Mixing effect is usually achieved through impeller design or by forcing the mixture through an annular opening that has a narrow entrance orifice with a much larger exit orifice.

Such existing uses of cavitation tend to use expensive or complicated equipment, and depending on the application, the time it takes for a cavitation-related process to complete can be the bottleneck in an industrial method.

### SUMMARY

A system and method for processing dispersed systems is disclosed. A dispersed system may be processed in a reactor, attached to which there may be a vibration unit, and one or more supply lines for gases and liquids. The dispersed system may be subjected to vibroturbulization as a way to mix and process the system. Various combinations of materials may be used in such an application, and both static and dynamic processing systems are possible.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

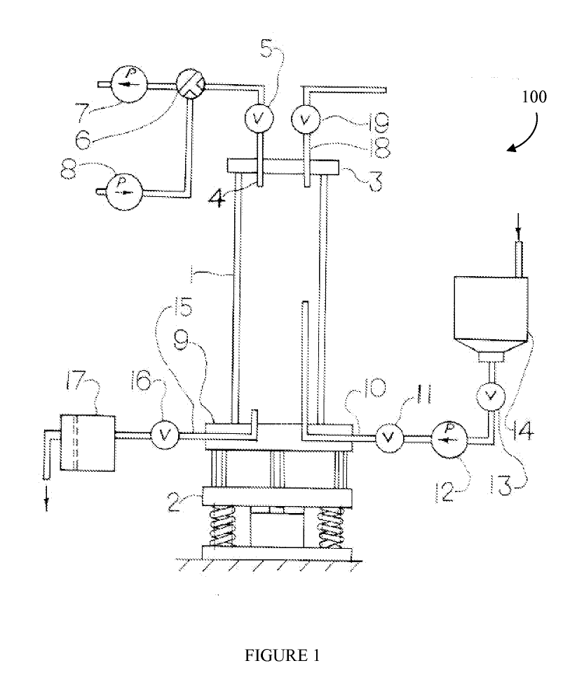

Exemplary FIG. 1 shows a schematic diagram of a system for processing dispersed systems.

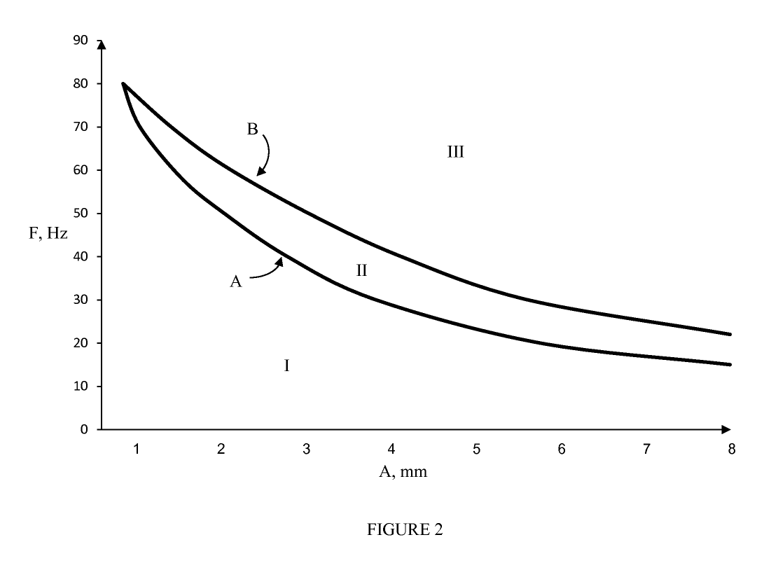

Exemplary FIG. 2 shows the phases of a sample liquid-gas system as dependent on amplitude and frequency of a vibrational field.

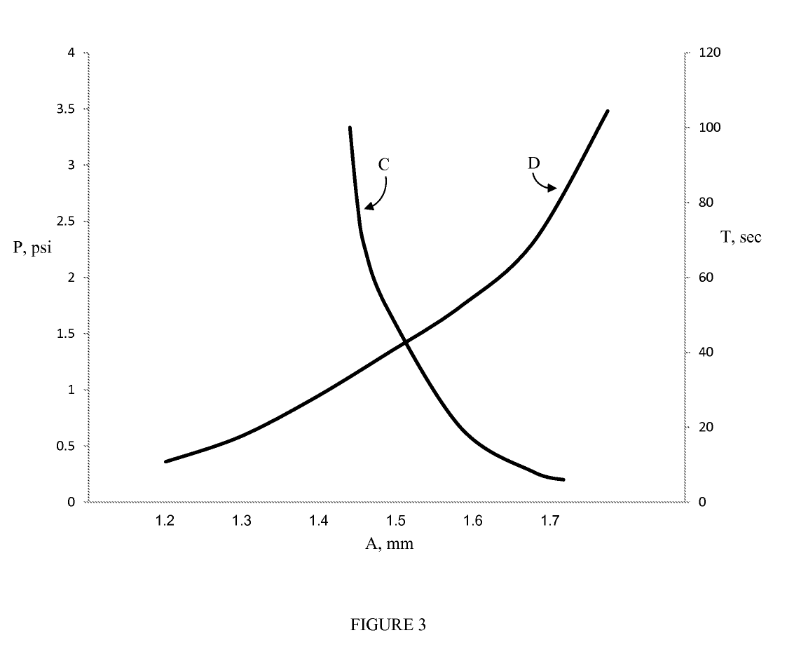

Exemplary FIG. 3 shows the relationship of pressure P and time T required for conversion to a vibroturbulization state.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

The disclosed physicochemical process and phenomenon, referred to herein as vibroturbulization, in the beginning may look like cavitation. However, the known cavitation phenomenon occurs when a liquid is pumped through an orifice, whereas according to one use of the disclosed vibroturbulization phenomenon, an impact pseudo-boil may form a substantially homogeneous liquid-gas system that may fill the internal volume of a sealed chemical apparatus when under certain low-frequency vibration conditions a dispersed liquid interacts with a dispersed gas. The source of the mechanical vibration may be a shaker. The disclosed apparatus may be installed on top of a vibration platform and the whole apparatus may vibrate under certain low-frequency vibration conditions.

The use of vibroturbulization may make it possible to simplify many processes in applied technology and, at the same time, essentially intensify them. Many time-consuming processes can be substantially accelerated.

The use of the vibroturbulization phenomenon may allow the production of a product of which the quality is equal to or better than those produced in traditional ways. Increased production and profitability are obvious benefits. This phenomenon may even make it possible to carry out processes previously impossible or economically not viable with traditional methods. Additionally, due to the inherent characteristics and increased mobility of the system, it may be possible to create new complex technological methods. This new process of chemical technology is capable of applying intensified energy to the processing system, which may promote the homogenization, emulsification, and preparation of suspensions, pastes, creams, foams, and the like, and also may promote reaction rates in extraction, recuperation, and other processes. A non-exhaustive list of the applications of the disclosed system and methods includes: the production of cosmetic creams, shampoos, and pastes; the production of food products such as mayonnaise and butter; the extraction of compounds from raw vegetative matter; the production of paints, varnishes, and enamels; the preparation of an emulsified growth medium for microbes; and any other production or preparation which may benefit from a high throughput of an emulsified, mixed, or dispersed product.

At the beginning of the process, as vibrational energy is applied to the system, the free surface of a given fluid may become ripple-coated, with the size of the ripples being proportional to oscillation frequency. As the amplitude grows, splashes and sprinkles may appear on the surface and separate gas bubbles may start penetrating into the liquid. Continued increase of the amplitude can result in mass bubble immersion. The bubble immersion may develop spontaneously in an avalanche-like way with the system pseudo-boiling and a state of vibroturbulization arrived at almost instantaneously. Research performed showed that there may be defined limits of the vibration fields in the process: the phase division zone, vibroturbulization zone, and quasicavitation zone, as described below. These zones are contingent upon the vibration parameters, dimensions of the reactor chamber, and the structural and mechanical properties of the processed chemical compounds.

A finite period of time may be required to bring the system to the vibroturbulization state. The length of this period depends on the accumulation of the appropriate amount of gas bubbles in the liquid. This period is variable from seconds to minutes because the conversion of the processed system into the vibroturbulization state depends on the vibration parameters, the content of the dissolved gas, the presence of surface-active compounds or intravenous inclusions, the irregularity of the reactor chamber's wall, the liquid-gas volume ratio, and the viscosity of liquids. Therefore, some minimal experimentation may be used to optimize a system when new parameters are used. In particular with liquid-gas systems, a ratio of 90-95% liquid to 5-10% gas may be preferable, but other ratios may also be used, depending on the application. Furthermore, according to at least one exemplary embodiment, once a desired ratio has been established and vibroturbulization has been reached, the user of the system disclosed herein may achieve a continuous production process. In the continuous production process, chemical compounds may be continually inputted as a processed, dispersed system is continuously outputted.

Additionally, in the process of achieving and using the vibroturbulization phenomenon, hydrodynamic heating of the system may be achieved. Further, the average pressure in the dispersed system may increase and remain at an elevated level during the entire time the vibroturbulization condition is maintained.

Referring to exemplary FIG. 1, a schematic for a chemical processing apparatus 100 may be disclosed. The apparatus 100 may be used for processing various dispersed systems, including liquid-liquid, liquid-gas, liquid-liquid-gas, liquid-solid, liquid-liquid-solid, liquid-liquid-solid-gas, or as desired. The apparatus 100 may include a reactor, a vibration unit, a gas supply line, a liquid supply line, a drainage line, and a ventilation line. The number of each sub-component may vary depending upon the application. Reactor 1 may be coupled to vibration unit 2. A gas supply line may include lid 3, pipe 4, check-valve 5, diverter valve 6, vacuum pump 7, and gas supply pump 8. A liquid supply line may include a lid 9, pipe 10, shut-off valve 11, supply pump 12, supply valve 13, and storage tank 14. A drainage line may include a pipe 15, shut-off valve 16, and drain tank 17. A ventilation line may include pipe 18 and valve 19.

Referring to exemplary FIG. 2, a phase diagram may show the phases of a sample liquid-gas system as dependent on amplitude, in millimeters, and frequency, in Hertz, of a vibrational field. Phase I denotes the phase where the free surface of the liquid-gas interface is preserved. Line A represents the appearance of single gas bubbles. Phase II denotes the phase where there is a coexistence of the free surface of the liquid and of the gas bubbles or their aggregates captured by the liquid. Line B represents the conversion of the system into the vibroturbulization state. Phase III is the vibroturbulization state, and in this phase a substantially homogenous hydrosol may be formed.

Exemplary FIG. 3 may show the relationship of pressure P and time T required for conversion to a vibroturbulization state when vibrating a sample liquid-gas system at 57 Hz. Line C shows the relationship of time to amplitude of the applied vibrational field to achieve vibroturbulization, and line D shows the relationship of pressure to amplitude of the applied vibrational field to achieve vibroturbulization.

When a system is undergoing vibroturbulization, the system may be subjected to vibrational forces with any of a variety of combinations of amplitude and frequency, depending on the application and the system being processed. For example, vibration with frequencies from 35 Hz to 100 Hz and amplitudes from 0.5 mm to 5 mm may be used. When undergoing vibroturbulization any of the following may occur:

a) The free surface of a processed liquid disappears;

b) The surface of separation between phases increases;

c) The processed dispersed system fills up the total internal volume of the reactor chamber;

d) The development of mass-transfer zones is observed;

e) Along with the increase of internal static pressure under vibroturbulization conditions, the development of fields of different internal pressure (pressure differentials) between different zones of chemical apparatus and mass-transfer are observed;

f) The sufficient intensification of specific sounds, accompanying the process of vibroturbulization.

Several exemplary embodiments follow, referring generally the description above and exemplary FIGS. 1-3:

According to a first exemplary embodiment, reactor chamber 1 may be filled with a liquid to be processed up to 95% of the internal volume. For this purpose valves 5 and 16 are closed; valves 11, 13, and 19 are open, and the necessary amount of liquid may be delivered from storage tank 14 by pump 12. Once the liquid and gas have been added to reactor chamber 1, all valves leading in and out of reactor chamber 1 may be closed, sealing the chamber.

The vibration effect on reactor chamber 1 may be achieved in several steps. In the first step the vibration amplitude may be maintained in range between 0.5 mm and 5 mm and the frequency may be dropped to the optimal level which brings the processed dispersed system to a vibroturbulization state. The optimal frequency can depend on the geometrical ratio between diameter and height of the chemical chamber, and the structural and mechanical characteristics of the processed systems and should be determined experimentally on a case-by-case basis, according to the principles set out above.

Upon achievement the optimal frequency, the processed dispersed system may convert into the vibroturbulization state. The appearance of massive bubbles and mass transfer zones may be observed. Along with an increase of the overall pressure inside the dispersed system and the development of pressure differentials between adjacent zones there may be changes in strength and tone of the specific accompanying sounds.

According to a second exemplary embodiment, reactor chamber 1 may be loaded up to 100% of the internal volume with a liquid to be processed and subjected to vibration with amplitude and frequency optimal to this particular system. After the vibration regimen becomes stable, valve 16 may be open, and the liquid from reactor chamber 1 may drain, for example by gravity, into tank 17. After the ratio between liquid and gas in reactor 1 reaches an optimal level, the processed dispersed system may convert into the vibroturbulization state spontaneously, achieving intensive mass-transfer and mass-exchange zones, an increase of pressure, development of fields of pressure differences, and changes in strength and tone of the specific accompanying sounds. The speed of liquid flow could be controlled by, for example, the opening of valve 16, the opening of valve 19, and/or the opening of valve 5 and pump 8. According to this or another embodiment, a continuous processing, including a continuous input and discharge, may be achieved.

According to a third exemplary embodiment, reactor chamber 1 may be subjected to vibration while empty with amplitude and frequency optimal to the system to be processed. After the vibration regimen becomes stable, valves 19 and valve 11 may be opened and the processing components are pumped into the reactor chamber 1 by delivery pump 12. Upon achieving the optimal ratio between liquid and gas, the system may convert into a vibroturbulization state instantly, achieving intensive mass-transfer and mass-exchange zones, an increase of pressure, development of fields of pressure differences, and changes in the strength and tone of specific accompanying sounds.

According to a fourth exemplary embodiment, reactor chamber 1 may be filled with a dispersed system to be processed to the optimal ratio for this particular liquid-gas (or other) combination. After the chemical chamber is filled, valves 5, 11, 16, and 19 may be closed, which may effectively seal reactor chamber 1, and vibration with amplitude and frequency optimal to this particular chamber and system may be applied. Upon the achievement of a critical number of bubbles in the liquid, the system may convert into a vibroturbulization state spontaneously, achieving intensive mass-transfer and mass-exchange zones, an increase of pressure, development of fields of pressure differences, and changes in the strength and tone of specific accompanying sounds.

According to a fifth exemplary embodiment, reactor chamber 1 may be filled with a system to be processed up to 100% of the internal volume of chemical chamber. Valves 5, 11, 16, and 19 are shut off and vibration, with amplitude and frequency which are close to but not exactly equal to optimal parameters, may be applied. After the vibration regimen becomes stable, valve 16 may opened, and a portion of processed liquid may drain into tank 17.

This use of the system may cause the occurrence of certain space filled with the saturated vapor of processed chemical components under the upper lid 3. Upon achievement of a critical number of bubbles in the liquid, the system may convert into a vibroturbulization state spontaneously, achieving intensive mass-transfer and mass-exchange zones, an increase of pressure, development of fields of pressure differences, and changes in the strength and tone of specific accompanying sounds.

According to a sixth exemplary embodiment, reactor chamber 1 may be pumped out by a vacuum pump 7. Valve 5 may be open, and valves 11, 16, and 19 may be closed. After the desired level of vacuum is reached the reactor chamber 1 may be subjected to vibration with amplitude and frequency close, but not exactly equal to optimal parameters. The chemical components may be loaded into the chamber by pump 12, through valve 11.

After the ratio between liquid and gas reaches an optimal level, the processed dispersed system may convert into a vibroturbulization state spontaneously, achieving intensive mass-transfer and mass-exchange zones, an increase of pressure, development of fields of pressure differences, and changes in the strength and tone of specific accompanying sounds.

According to a seventh exemplary embodiment, reactor chamber 1 may be filled with a system to be processed in the optimal ratio and then may be subjected to vibration with amplitude and frequency optimal for this particular reactor chamber and system to be processed. For the purpose of achieving intensification of the turbulent state, an initiator—a small amount of gas or liquid with a different coefficient of surface tension, may be administered into the chamber. Upon achieving the optimal ratio between liquid and gas, the system may convert into a vibroturbulization state instantly.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1-20. (canceled)

21. A method for processing dispersed systems, comprising:
inputting a first component into a reactor chamber;
inputting a second component into a reactor chamber; and
applying a constant vibration to the reactor chamber;
wherein the vibration applied to the reactor chamber has a frequency and amplitude to achieve vibroturbulization.

22. The method for processing dispersed systems of claim 21, wherein the vibration applied to the reactor chamber has a frequency between 35-100 Hz, inclusive, and amplitude between 0.5 and 5 mm, inclusive.

23. The method for processing dispersed systems of claim 21, wherein the first component is a liquid and the second component is a gas.

24. The method for processing dispersed systems of claim 21, wherein the vibration is applied to the reactor chamber after inputting the first component and before inputting the second component.

25. The method for processing dispersed systems of claim 21, wherein the vibration is applied to the reactor chamber before inputting either of the first component and the second component.

26. The method for processing dispersed systems of claim 21, further comprising draining a final-processed product.

27. The method for processing dispersed systems of claim 21, further comprising sealing the reactor chamber.

28. The method for processing dispersed systems of claim 21, further comprising inputting a third component into the reactor chamber.

29. The method for processing dispersed systems of claim 28, wherein the third component has a surface tension coefficient which is different from the surface tension coefficient of either of the first component and the second component.

30. A method for continuous processing of dispersed systems, wherein a vibroturbulization is accompanied by:
a free surface between the components of a multi-component mixture disappears;
the surface of separation between the components of the multi-component mixture increases;
the multi-component mixture filling up the total internal volume of a reactor chamber;
the development of mass-transfer zones;
the increase of internal pressure in the reactor chamber; and
the intensification of specific sounds from the reactor chamber.

31. The method for continuous processing of dispersed systems of claim 30, wherein a processed product is continuously discharged from the reactor chamber while the multi-component mixture is in a state of vibroturbulization.

32. A method for processing dispersed systems, wherein a vibroturbulization phenomenon is achieved in a cylindrical reactor vertically installed on a shaker, comprising:
applying vertical sinusoidal oscillation;
matching a compelled frequency with a natural oscillation of a processing system loaded into a reactor chamber,
causing a resonance of the processing system;
achieving a vibroturbulization by a combined action of resonance and a hydraulic hammer effect,
wherein upon achieving vibroturbulization a liquid component loses its continuum and the processing mixture inside the reactor chamber converts into a dispersing system, where a gas and a solid are dispersed phases and the liquid is a dispersing medium.

33. The method for processing dispersed systems of claim 32, wherein the processing of the dispersed system is conducted under a condition of developed vibroturbulization inside a chemical chamber that is subject to vibration with frequencies from 35 Hz to 100 Hz, and amplitudes from 0.5 mm to 5 mm, where an optimal frequency and amplitude parameters are necessary for achievement of the vibroturbulization depending upon the geometric parameters of the chemical chamber, and the rheological, structural and mechanical characteristics of the dispersed system to be processed, and the optimum ratio between components.

34. The method for processing dispersed systems of claim 32, wherein the multi-component mixture is one of a liquid-liquid, liquid-liquid-gas, liquid-liquid-solid, or liquid-liquid-solid-gas is filing of 90-95% of internal volume of reactor chamber.

35. The method for processing dispersed systems of claim 32, wherein while a multi-component mixture is in a state of vibroturbulization, a processed product in the reactor is continuously loading into at least one low-pressure mass-transfer zone, and a final product is discharged from at least one high-pressure mass-transfer zone.

36. The method for processing dispersed systems of claim 32, wherein a regimen of developed vibroturbulization is controlled by use of a strength and tone of accompanying sounds.

37. The method for processing dispersed systems of claim 36, wherein the regiment of developed vibroturbulization is controlled by means of changing the ratio between volume of phases loaded in the reactor chamber and the internal volume of reactor chamber.

38. The method for processing dispersed systems of claim 36, wherein the regiment of developed vibroturbulization is achieved at a fixed frequency, amplitude, and optimal ratio between phases in a chemical chamber by administering an initiator.

39. The method for processing dispersed systems of claim 32, wherein processing of dispersed systems is performing under vacuum for expansion of the application of the vibroturbulization.
